(19) United States
(12) Patent Application Publication
(10) Pub. No.: US 2004/0086329 A1
(43) Pub. Date: May 6, 2004

(54) Ornamental tube machine and method for using same

(76) Inventor: Vincent Sorrentino, Poinciana, FL (US)

Correspondence Address: LOTT & FRIEDLAND, P.A., P.O. BOX 141098, CORAL GABLES, FL, 33114-1098, US

(21) Appl. No.: 10/288,007

(22) Filed: Nov. 5, 2002

(51) Int. Cl. B25G 3/28

(52) U.S. Cl. 403/279; 72/370.08

(57) ABSTRACT

A machine for deforming metal tubes to resemble the culm of a bamboo plant, and a method for using same.

### FIELD OF INVENTION

The present invention relates generally to the field of metalworking, and more particularly, to an apparatus designed to deform metal tubes into a pre-selected decorative shape.

### BACKGROUND OF THE INVENTION

New furniture is always in demand by consumers in the United States and abroad. Today's economy has created a particularly hospitable environment for furniture manufacturers. Low interest rates have stimulated new housing starts and sales. New-home sales for August of this year were pegged at 996,000, up 1.9% from July and 14.4% from August of last year. New-home sales have trended up throughout the past year, and August's number was up 16.4% from the 13-month low of 856,000 in September 2001. New housing typically translates to higher sales numbers for the furniture industry. If furniture spending continues at the present pace, it will finish the year at $66.8 billion, up sharply from 2001's $64 billion. http://www.furnituretoday.com/news/news10-14-02d.shtml.

A sub-segment of the consumer furniture industry is metal furniture. Although metal furniture is often used for businesses, residential metal furniture sales continue to rise with the overall trends, particularly for outdoor and enclosed patio usage. A large proportion of metal furniture has, for many years, been made from tubular metal. Even with the much wider range of materials available today, tubular metal still forms the major part of the market particularly for folding furniture. Tubular metal furniture is made either from steel tube, zinc plated or plastic coated or from aluminum alloy tube and is, therefore, is highly resistant to attack from the weather.

Aluminum alloy tube is used extensively and, since it is rust proof, it requires no surface coating. Slight surface oxidation can take place, particularly near the sea, leading to a light coating of white dust on the surface. Although this can be polished off it will, if left in place, prevent any further oxidation. Aluminum alloy frames have the advantage of being very light and are therefore used extensively for camping furniture, particularly picnic sets.

Metal furniture, although typically more durable than traditional wooden furniture, does not inherently have the aesthetically pleasing wood patterns of natural wooden furniture. Of particular popularity is the shape. of the bamboo culm, with its segmented, straight and long shape, divided by nodes comprised of two essentially parallel ribs. Metal furniture has in the past been made to look like bamboo, by welding strips of metal around a metal tube to give the illusion of a bamboo node.

Previous attempts have been made to provide attractive metal furniture such as described in U.S. Pat. No. D421,688 to Doud, et al. ('688 patent); U.S. Pat. No. D398,463 to Olson ('463 patent); U.S. Pat. No. 4,564,111 to Suttles ('111 patent); U.S. Pat. No. 4,518,279 to Suttles ('279 patent); and U.S. Pat. No. 4,265,500 to Berton, et al. ('500 patent); all of which are incorporated herein by reference.

The '688 patent describes an ornamental design for metal furniture components, however, the design does not resemble bamboo.

The '463 patent also describes an ornamental design for metal furniture components, however, the design does not resemble bamboo.

The '111 patent describes sheet metal base panels in merchandising display stands that are connected to sheet metal posts by the insertion of tabs into spaces between planar post sections and return flanges through slots. Projections on the tabs are engaged by oblique edges which exert a wedging action, tightening the engagement between the panels and the posts. In one version, the oblique edge is an edge of the return flange itself, and as the tab is inserted, it spreads the return flange away from the planar section of the post until the projection on the tab clears the oblique edge of the return flange, whereupon the flange snaps into place. A downward force exerted through the post by the weight of articles supported on the display stand effects a tightening action. In another version of the invention, a separate locking element having two wedges is vertically slidable in the post, and is moved into engagement with locking projections on tabs of the base panels of a merchandising unit. Each locking element has two wedges connected together by abridge which has a projection extending away from the post for engagement by a tool or a shoe, by which the locking element can be urged downwardly. Although this invention is for metal furniture it does not provide a machine for deforming metal tubes into a pre-selected shape.

The '279 patent describes a fastener-free merchandising display stand, which is rigid when initially assembled, and which remains rigid during use, comprises interconnected perpendicular base panels which meet at a sheet metal upright. One of the panels is rigidly welded to the upright, while the other panel is connectable to the first panel and the upright by sliding it vertically downwardly into a pocket formed by a section of the post and a section of the first panel extending perpendicularly from the face thereof and having an oblique, flanged edge. The second panel has a flange with an oblique edge which fits into the pocket. The second panel is tightened against the upright as it slides downwardly by a wedging action, so that the weight of the second panel tends to cause the interconnection to remain tight even if a slight bending of sheet metal parts takes place as a result of abuse. Although this invention is for metal furniture it does not provide a machine for deforming metal tubes into a pre-selected shape.

The '500 patent describes a piece of metal furniture in sectional units comprising a base, two side panels, and a rear panel assembly. the assembly of these pieces is very simple and can be done by unskilled persons and without the use of any special tools or equipment. The base comprises complementary elements and locking devices which cooperate with corresponding parts of the side panels to allow the parts to be assembled and to be locked together, while taking up any relative play therebetween. The units are all of substantially parallelepipedal shape, resulting in less space being needed either for storing or for transport. The rear panel assembly is a modular assembly of individual rear panels wherein at least one dimension of the rear panel assembly is a multiple of the dimension of the base. Rear panels have the side edges which are suitably folded and shaped so as to interconnect with one another and with corresponding edges of the side panels. Considerable savings in production costs are made since all the units which make up the piece of furniture are obtained by using sheets of metal of restricted size. Although this invention is for metal furniture it does not provide a machine for deforming metal tubes into a pre-selected shape.

Accordingly, there is a need in the art for a machine capable of deforming a metal tube into a pre-selected ornamental shape.

There is a further need in the art for a method of deforming a metal tube into a pre-selected ornamental shape.

There is a further need in the art for a metal tube deformed into a pre-selected ornamental shape for use in the manufacture of furniture.

### SUMMARY OF THE INVENTION

The present invention solves significant problems in the art by providing a machine capable of deforming a metal tube into a pre-selected ornamental shape, a method of deforming a metal tube into a pre-selected ornamental shape, and a metal tube deformed into a pre-selected ornamental shape for use in the manufacture of furniture.

A preferred embodiment of the invention, provides a machine for deforming a metal tube into a pre-selected decorative shape, comprising a means for providing movement to a rod, wherein attached to the rod is an expander plug; and a tool for defining the decorative shape, wherein movement of the expander plug into the tool deforms the metal tube.

In an alternative embodiment, the invention provides a machine for deforming a metal tube into the shape of a bamboo plant culm, comprising a means for providing movement to a rod, wherein attached to the rod is an expander plug; a pilot shaft; and a tool for defining the bamboo plant culm shape, wherein movement of the expander plug into the tool deforms the metal tube.

In a further alternative embodiment, the invention provides a method for deforming a metal tube into a pre-selected decorative shape, comprising the steps of: inserting the metal tube onto a pilot shaft; causing movement of an expander plug into a tool, wherein the tool applies the pre-selected decorative shape to the metal tube; causing movement of the expander plug out of the tool; and, removing the tube from the pilot shaft.

In a further alternative embodiment, the invention provides a method for deforming a metal tube into the shape of a bamboo plant culm, comprising the steps of inserting the metal tube onto a pilot shaft; causing movement of an expander plug into a tool, wherein the tool applies the shape of a bamboo plant culm to the metal tube; causing movement of the expander plug out of the tool; and removing the tube from the pilot shaft.

In a further alternative embodiment, the invention provides a metal tube which contains at least one set of proximal parallel protruding ribs, the ribs created by inserting the metal tube onto a pilot shaft; causing movement of an expander plug into a tool, wherein the tool applies the pre-selected decorative shape to the metal tube; causing movement of the expander plug out of the tool; and removing the tube from the pilot shaft.

Accordingly, it is an object of the present invention to provide a machine capable of deforming a metal tube into a pre-selected ornamental shape.

It is another object of the present invention to provide a method of deforming a metal tube into a pre-selected ornamental shape.

It is another object of the present invention to provide a metal tube deformed into a pre-selected ornamental shape for use in the manufacture of furniture.

These and other objects, features and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is a side view of a preferred embodiment of the ornamental tube machine according to the invention.

FIG. 2 is a top view of a preferred embodiment of the ornamental tube machine according to the invention.

FIG. 3 is an illustration of the double rib tool according to the invention.

FIG. 4 is an illustration of the double rib formation on a metal tube.

FIG. 5 is an illustration of furniture made from the product of the ornamental tube machine.

### DETAILED DESCRIPTION OF THE PREFERRED EMBODIMENT

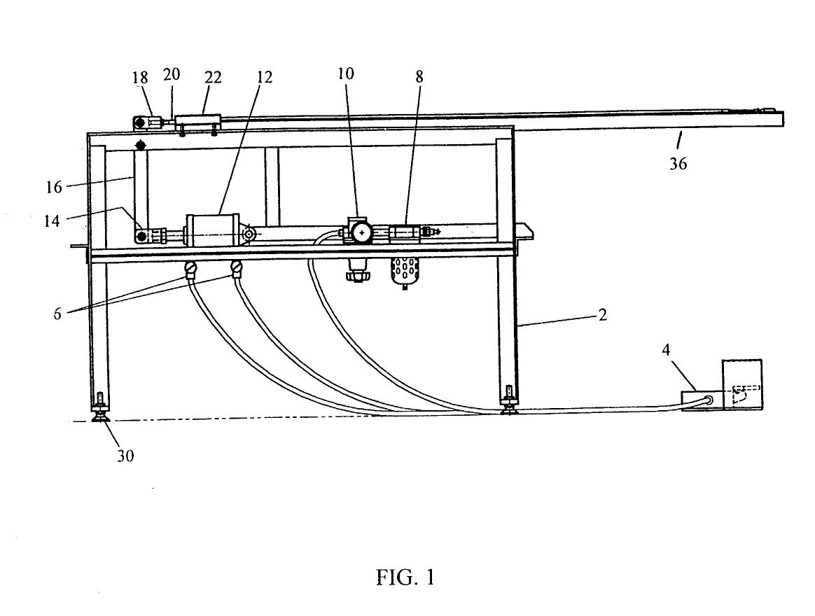

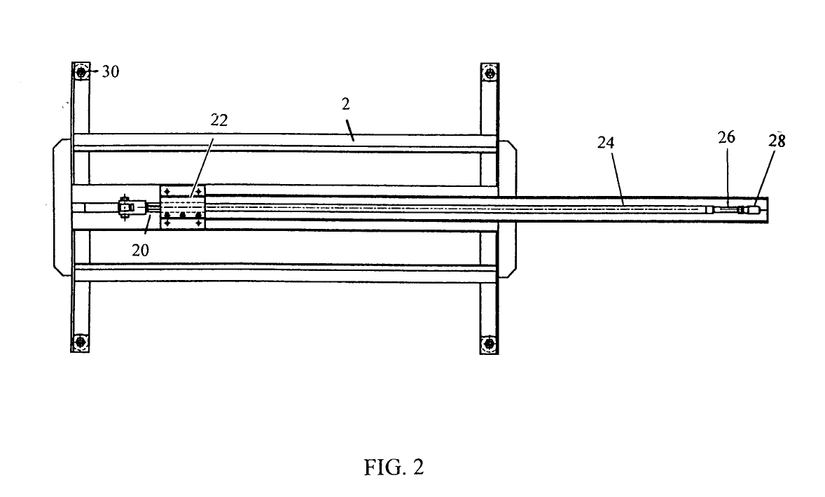

Referring initially to FIG. 1 of the drawings, in which like numerals indicate like elements throughout the several views, in a preferred embodiment the ornamental tube machine is shown from the side. The frame 2 provides a superstructure for the operational elements of the invention. Operation of the machine is commenced by depressing the foot valve 4. The foot valve 4 regulates compressed air flow to the air cylinder 12 through the flow continuation valves 6. In addition, the air is controlled by a pressure regulator 10 for safety, and an air filter 8. The airflow into the air cylinder 12 causes it to move like a piston, which in turn provides motion to the lever 16. Depressing the foot valve 4 causes the air cylinder 12 to move to its furthest operational position and releasing the pressure on the foot valve 4 returns the air cylinder 12 to its at rest position. At either end of the lever is a clevis 14 and 18. The cylinder clevis 14 and the rod clevis 18 attach the lever 16 to the air cylinder 12 and the rod 20. As the air cylinder 12 is pumped by a user, using the foot valve 4, it moves back and forth causing the lever to move the rod 20 back and forth along the length of the pilot shaft 24, depicted in FIG. 2. The rod 20 runs through the hollow pilot shaft 24 and terminates at the expander plug 28. The pilot shaft 24 is attached to the frame 2 by the clamp block 22 and extends nearly the length of the frame arm 36, terminating at the double rib tool 26. Movement of the rod 20 causes the expander plug to move into and out of the double rib tool 26. An adjustable leveling mount 30 is provided at each of the legs of the frame 2 to provide stability to the machine.

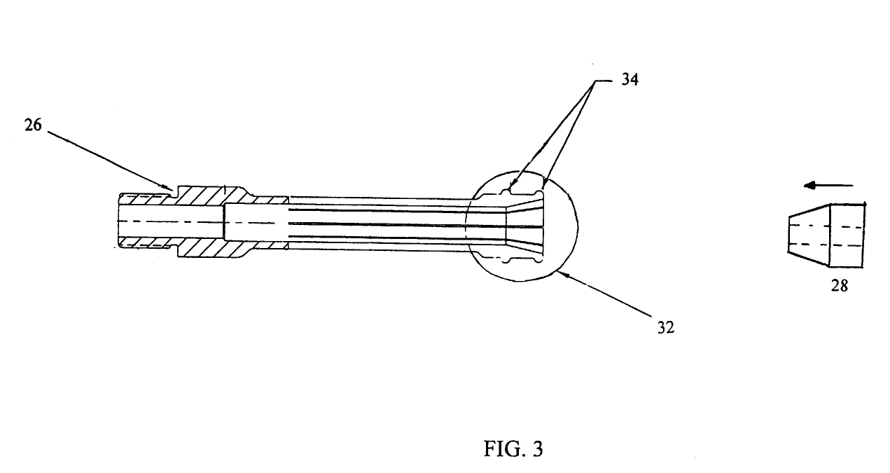

The double rib tool 26 is illustrated in detail in FIG. 3. The expander plug 28 is pulled into the double rib tool 26 by the rod 20. As the expander plug 28 enters the double rib tool 26, the flared end 32 expands outward towards the rib grooves 34. As the expander plug 28 returns to its original position, away from and out of the flared end 32, the deformable members of the flared end 32 return to their original positions. The flared end 32 is typically constructed of a shape-memory alloy.

In operation then, a hollow metal tube is inserted into the machine first at the end proximal to the expanderplug 28. The tube is positioned so that the section of the metal tubedesired to be deformed is directly contiguous to the rib grooves 34. The metal tube encloses all operative parts including the expander plug 28, the rod 20, the double rib tool 26 and the pilot shaft 24. As the expander plug moves into the flared end 32 of the double rib tool 26 and the flared end 32 expands, it exerts pressure on the inside of the metal tube at those points. At the location of the rib grooves 34, there is no external counter pressure exerted by the frame 2 of the machine, and therefore the internal pressure exerted there by the flared end 32 causes the metal to deform outwards into the grooves 34 and taking the shape of the grooves 34.

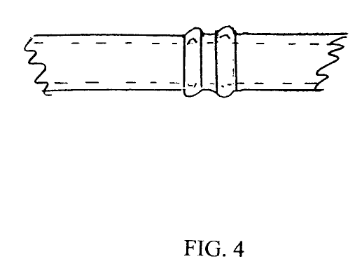

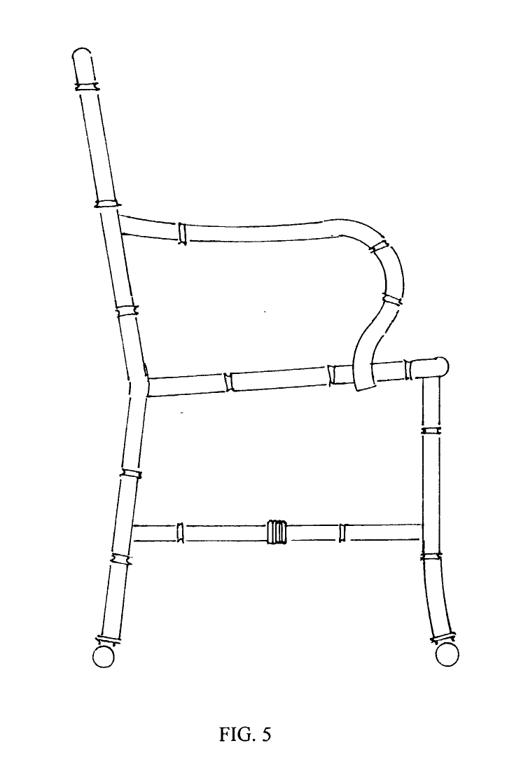

If it is desirable to deform a metal tube far down the length of the tube, the tube can be slid down the frame arm 36, and along the pilot shaft 24, as far as the clamp block 22. It can be seen from this operational setup that the longer the frame arm 36, the longer the metal tube that can be used with the machine. Also noteworthy, a tube can be inserted into the machine from one end, and be deformed at any point along its length from the clamp block 22 to the double rib tool 26, but can then be taken off and turned around, inserting the other end of the metal tube into the machine, effectively doubling the workable length of the tube. FIGS. 4 and 5 are illustrations of the impression made by the invention on a metal tube and a finished product using metal tubes deformed in the above-described fashion.

Tubes constructed in the manner described above can be used for a variety of purposes and can be constructed of various materials, although more malleable metals, such as aluminum, are more easily used with the present invention. Examples of the tubes flexibility comprise uses for fencing, door frames, security bars (e.g. on windows), railings and balustrades.

Accordingly, it will be understood that the preferred embodiment of the present invention has been disclosed by way of example and that other modifications and alterations may occur to those skilled in the art without departing from the scope and spirit of the appended claims.

What is claimed is:

1. A machine for deforming a metal tube into a decorative shape, comprising:
means for providing movement to a rod;
an expander plug attached to said rod; and,
a tool for defining said decorative shape, wherein movement of said expander plug into said tool deforms said metal tube.

2. The machine of claim 1, wherein said movement-providing means utilizes air pressure to move an air cylinder, said air cylinder providing movement to said rod.

3. A machine for deforming a metal tube into the shape of a bamboo plant culm, comprising:
means for providing movement to a rod;
an expander plug attached to said rod;
a pilot shaft; and, a tool for defining said bamboo plant culm shape, wherein movement of said expander plug into said tool deforms said metal tube.

4. The machine of claim 3, wherein said movement-providing means utilizes air pressure to move an air cylinder, said air cylinder providing movement to said rod.

5. A method for deforming a metal tube into a decorative shape, comprising the steps of:
inserting said metal tube onto a pilot shaft;
causing movement of an expander plug into a tool, wherein said tool applies said decorative shape to said metal tube;
causing movement of said expander plug out of said tool; and,
removing said tube from said pilot shaft.

6. A method for deforming a metal tube into the shape of a bamboo plant culm, comprising the steps of:
inserting said metal tube onto a pilot shaft;
causing movement of an expander plug into a tool, wherein said tool applies said shape of a bamboo plant culm to said metal tube;
causing movement of said expander plug out of said tool; and,
removing said tube from said pilot shaft.

7. A metal tube which contains at least one set of proximal parallel protruding ribs, said ribs created by inserting said metal tube onto a pilot shaft; causing movement of an expander plug into a tool, wherein said tool applies said proximal parallel protruding ribs to said metal tube; causing movement of said expander plug out of said tool; and, removing said tube from said pilot shaft.

8. The metal tube of claim 7, wherein said tube is used in the manufacture of furniture.

9. The metal tube of claim 7, wherein said tube is used in the manufacture of fencing.

10. The metal tube of claim 7, wherein said tube is used in the manufacture of door frames.

11. The metal tube of claim 7, wherein said tube is used in the manufacture of security bars.

12. The metal tube of claim 7, wherein said tube is used in the manufacture of railings.

13. The metal tube of claim 7, wherein said tube is used in the manufacture of balustrades.
